(19) United States
(12) Patent Application Publication
(10) Pub. No.: US 2010/0185806 A1
(43) Pub. Date: Jul. 22, 2010

(54) CACHING SYSTEMS AND METHODS USING A SOLID STATE DISK

(76) Inventors: Arvind Pruthi, Los Gatos, CA (US); Ram Kishore Johri, San Jose, CA (US)

Correspondence Address: HARNESS, DICKEY & PIERCE P.L.C., 5445 CORPORATE DRIVE, SUITE 200, TROY, MI, 48098, US

(21) Appl. No.: 12/685,909

(22) Filed: Jan. 12, 2010

Related U.S. Application Data
(60) Provisional application No. 61/145,369, filed on Jan. 16, 2009.

(51) Int. Cl. G06F 12/00; G06F 12/02; G06F 12/10

(52) U.S. Cl. 711/103; 711/206; 711/E12.001; 711/E12.008; 711/112

(57) ABSTRACT

A system includes a control module, a location description module, and a page invalidation module. The control module is configured to write data received from a host to a storage medium, read data from the storage medium, and cache data from at least one of the host and the storage medium in a flash memory. The location description module is configured to map one of a valid and invalid state to a physical location of a subset of data in the flash memory. The page invalidation module is configured to receive a command from one of the host and the control module that includes an address corresponding to the subset and an instruction to set a state of the physical location to the invalid state. The page invalidation module is further configured to set the state of the physical location to the invalid state in response to the command.

### CROSS-REFERENCE TO RELATED APPLICATIONS

This application claims the benefit of U.S. Provisional Application No. 61/145,369, filed on Jan. 16, 2009. The disclosure of the above application is incorporated herein by reference in its entirety.

### FIELD

The present disclosure relates to a caching system, and more particularly to a caching system using flash memory.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Referring now to FIG. 1, a host system 102 may communicate with a storage device 104 via a cache system 106. The host system 102 may include a computer system, such as a personal computer, a consumer electronics device, etc. The storage device 104 may include a hard disk drive (HDD).

The cache system 106 may serve as a temporary storage area that stores data that the host system 102 frequently accesses from the storage device 104. The host system 102 may access data faster from the cache system 106 than the storage device 104. Accordingly, the cache system 106 may reduce access times when the host system 102 repeatedly accesses data that is stored in the cache system 106. However, the cache system 106 may not reduce access times when the host system 102 requests data that is not stored in the cache system 106.

The cache system 106 includes a control module 108 and cache memory 110. The control module 108 reads/writes data from/to the cache memory 110 and the storage device 104. The host system 102 requests data from the storage device 104 via the control module 108. The control module 108 retrieves the requested data from one of the cache memory 110 and the storage device 104 and sends the requested data to the host system 102.

The control module 108 determines whether the requested data is stored in the cache memory 110. The control module 108 may retrieve the requested data from the cache memory 110 when the control module 108 determines that the cache memory 110 includes the requested data.

The control module 108 may retrieve the requested data from the storage device 104 when the cache memory 110 does not include the requested data. The control module 108 may store data retrieved from the storage device 104 in the cache memory 110 when the cache memory 110 does not include the requested data.

The control module 108 may retrieve the requested data faster from the cache memory 110 than the storage device 104. For example, when the cache memory 110 is a dynamic random access memory (DRAM) and the storage device 104 is a HDD, the control module 108 may access the DRAM faster than the HDD. Accordingly, the cache system 106 may function to reduce a data retrieval time for the host system 102.

The host system 102 may command a write to at least one of the cache memory 110 and the storage device 104. The control module 108 may write data to the cache memory 110 in response to the write command, then write the data to the storage device 104 at a later time. Accordingly, the cache system 106 may act as a buffer when the host system 102 commands a write to the storage device 104. The control module 108 may also write data to both the storage device 104 and the cache memory 110 in parallel in response to the write command. Accordingly, the cache system 106 may cache data written to the storage device 104 in the cache memory 110.

### SUMMARY

A system comprises a control module, a location description module, and a page invalidation module. The control module is configured to write data received from a host system to a storage medium, read data from the storage medium, and cache data from at least one of the host system and the storage medium in a flash memory. The location description module is configured to map one of a valid state and an invalid state to a physical location of a subset of data in the flash memory. The page invalidation module is configured to receive a command that includes an address corresponding to the subset and an instruction to set a state of the physical location of the subset to the invalid state. The page invalidation module is further configured to set the state of the physical location of the subset to the invalid state in response to the command. The command is received from one of the host system and the control module.

In other features, the storage medium includes one of a magnetic storage medium and an optical storage medium.

In other features, the flash memory includes a NAND flash memory.

In other features, the system further comprises a location mapping module configured to map the physical location of the subset to a logical address. The logical address corresponds to a physical location on the storage medium.

In other features, the location mapping module includes a map that relates the physical location of the subset to the logical address. The location mapping module updates the map to indicate that no data is stored at the logical address when the page invalidation module sets the state of the physical location of the subset to the invalid state.

In other features, the system further comprises a defragmentation module configured to defragment a block of the flash memory that includes the subset. The page invalidation module sets the state of the physical location of the subset to the invalid state in response to the command.

In still other features, a method comprises writing data received from a host system to a storage medium, reading data from the storage medium, and caching data from at least one of the host system and the storage medium in a flash memory. The method further comprises mapping one of a valid state and an invalid state to a physical location of a subset of data in the flash memory. The method further comprises receiving a command that includes an address corresponding to the subset and an instruction to set a state of the physical location of the subset to the invalid state. Additionally, the method comprises setting the state of the physical location of the subset to the invalid state in response to the command. The command is received from one of the host system and the control module.

In other features, the method comprises reading data from one of a magnetic storage medium and an optical storage medium.

In other features, the method comprises caching data from at least one of the host system and the storage medium in a NAND flash memory.

In other features, the method comprises mapping the physical location of the subset to a logical address that corresponds to a physical location on the storage medium.

In other features, the method comprises updating a map to indicate that no data is stored at the logical address when setting the state of the physical location of the subset to the invalid state. The map relates the physical location of the subset to the logical address.

In other features, the method comprises defragmenting a block of the flash memory that includes the subset and setting the state of the physical location of the subset to the invalid state in response to the command.

In still other features, the systems and methods described above are implemented by a computer program executed by one or more processors. The computer program can reside on a computer readable medium such as but not limited to memory, nonvolatile data storage, and/or other suitable tangible storage mediums.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

The present disclosure will become more fully understood from the detailed description and the accompanying drawings, wherein:

FIG. 1 is a functional block diagram of a cache system;

FIG. 2 is a functional block diagram of a flash memory system;

FIG. 3 is a functional block diagram of a flash memory system that includes a flash management module;

FIG. 4 is a diagram of a block and page arrangement of a flash memory;

FIG. 5A is a diagram of a logical block address (LBA) to physical location map of a flash memory;

FIG. 5B is a diagram of a physical location description table of a flash memory;

FIG. 6 is a functional block diagram of a flash memory cache system according to the present disclosure;

FIG. 7 is a functional block diagram of a flash memory cache system that includes a page invalidation module according to the present disclosure;

FIG. 8 is a diagram of a cache address table; and

FIG. 9 illustrates a method for invalidating a physical location of a flash memory according to the present disclosure.

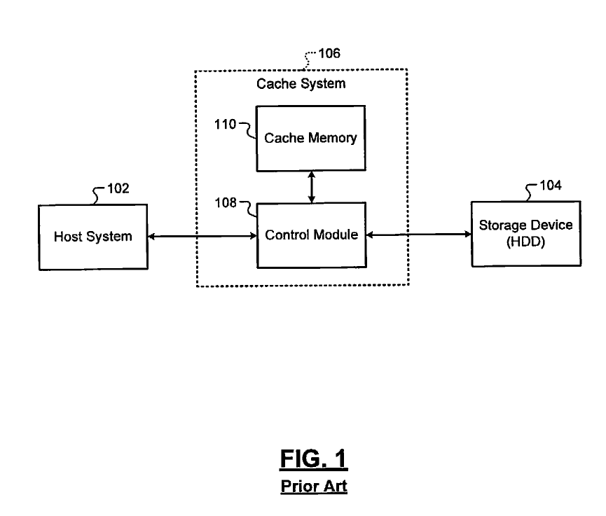

### DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical OR. It should be understood that steps within a method may be executed in different order without altering the principles of the present disclosure.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

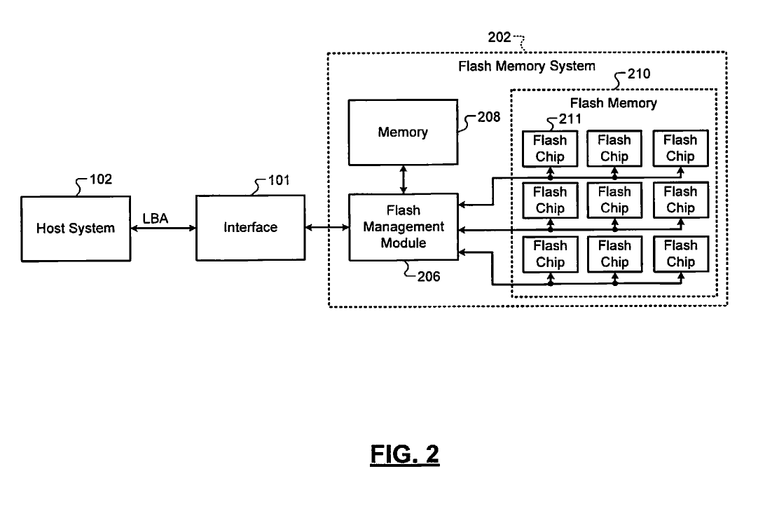

Referring now to FIG. 2, the host system 102 may communicate with a flash memory system 202 via an interface 101. The host system 102 may include a computer, a multimedia device, a mobile computing device, etc. For example, the interface 101 may include an advanced technology attachment (ATA) interface, a serial ATA (SATA) interface, etc.

The flash memory system 202 includes a flash management module 206, memory 208, and a flash memory 210. The host system 102 reads/writes data from/to the flash memory 210 via the flash management module 206. The host system 102 may communicate with the flash management module 206 using a logical block addressing (LBA) scheme. An address specified in a LBA scheme may be referred to as “logical address.” Accordingly, the host system 102 may request data from the flash memory 210 at a logical address. For example, logical addresses may be denoted as LBA 1, LBA 2, etc.

The flash memory 210 may include a plurality of flash chips 211. The flash memory 210 may include at least one of NAND flash memory and NOR flash memory. The flash management module 206 reads/writes data from/to the flash memory 210. Additionally, the flash management module 206 performs other operations on the flash memory 210. Other operations may include erasing portions of the flash memory 210 and defragmenting the flash memory 210.

The flash management module 206 may store data from the flash memory 210 in the memory 208 when erasing the flash memory 210 and when defragmenting the flash memory 210. The flash management module 206 may buffer data in the memory 208. For example, the flash management module 206 may buffer data to be written to the flash memory 210 in the memory 208. The flash management module 206 may also buffer data read from the flash memory 210 in the memory 208 to be subsequently transferred to the host system 102.

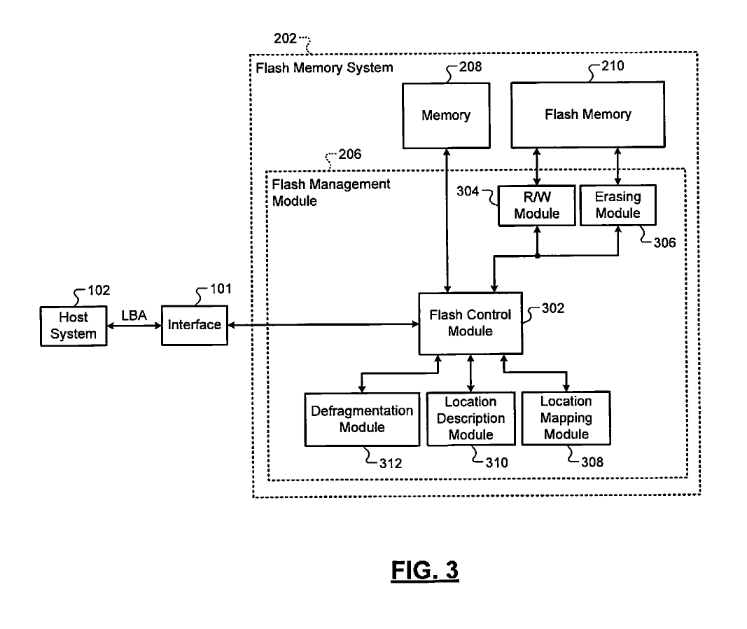

Referring now to FIG. 3, the flash management module 206 includes a flash control module 302, a read/write (R/W) module 304, an erasing module 306, a location mapping module 308, a location description module 310, and a defragmentation module 312.

The flash control module 302 sends/receives data to/from the host system 102. The flash control module 302 instructs the R/W module 304 to read/write data from/to the flash memory 210. The flash control module 302 instructs the erasing module 306 to erase data from the flash memory 210. The flash control module 302 instructs the location mapping module 308 to map a logical address to a physical location of data in the flash memory 210. The flash control module 302 instructs the location description module 310 to map the validity of data in the flash memory 210. The flash control module 302 performs a defragmentation operation on the flash memory 210 via the defragmentation module 312.

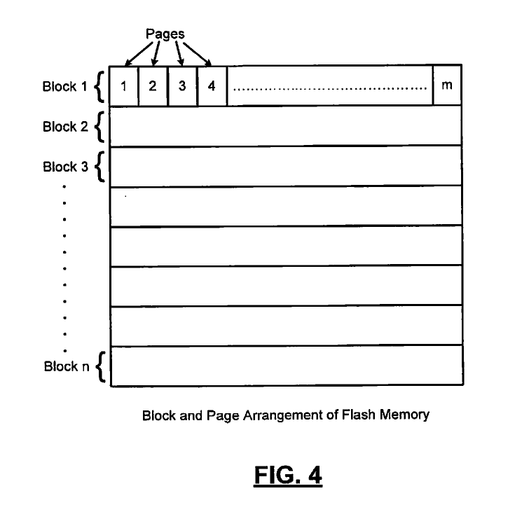

Referring now to FIG. 4, a diagram illustrating an exemplary block and page arrangement of the flash memory 210 is shown. The flash memory 210 includes n erase blocks (hereinafter “blocks”). Each block includes m pages. For example only, a block may be 256 KB to 512 KB in size and a page may be 4 KB in size. Accordingly, a block may include 64-128 pages.

The erasing module 306 erases data from the flash memory 210 in units of blocks. For example, the erasing module 306 erases one or more blocks when erasing data from the flash memory 210.

The R/W module 304 reads/writes data from/to the flash memory 210 in units of pages. Accordingly, the R/W module 304 reads/writes data from/to one or more pages when reading/writing data from/to the flash memory 210. The R/W module 304 may write data to a page after the page is erased. The R/W module 304 may not write data to a page when the page includes previously written data until the erasing module 306 has erased the page.

The R/W module 304 may initially write to pages in a block in sequential order after the erasing module 306 has erased the block. For example, after block 1 is erased, the R/W module 304 may write data to the flash memory 210 starting at page 1 of block 1 and write data to each consecutive page until reaching page m of block 1.

The R/W module 304 may not write data to a page in a block that precedes a page in the block that includes data. For example, the R/W module 304 may not write to pages 1-19 within a block when data has been written to page 20 of the block. However, the R/W module 304 may write to pages 1-19 after the erasing module 306 erases the block that includes pages 1-19.

Referring back to FIG. 3, the location mapping module 308 includes an LBA to physical location map (hereinafter “location map”). The location map relates a logical address to a physical location in the flash memory 210. For example, the location map relates a logical address to a block number and a page number of the flash memory 210.

The location mapping module 308 updates the location map when the R/W module 304 writes data to the flash memory 210. The flash control module 302 may receive a command to write data to a logical address that was previously written. In other words, the flash control module 302 may receive multiple commands to write to the same logical address. Since the R/W module 304 may not overwrite data at a physical location that has been written without first erasing the data already written, the R/W module 304 writes the data to a new physical location. The location mapping module 308 updates the location map to include the new physical location corresponding to the logical address.

To more specifically describe the process of writing data to the flash memory 210, writing of new data to a logical address K may be performed as follows. The flash control module 302 receives a command from the host system 102 to write data to LBA K. The flash control module 302 instructs the R/W module 304 to write the data to a physical location X in the flash memory 210. For example, X may be a next available physical location in the flash memory 210. The R/W module 304 then writes to the physical location X. The location mapping module 308 then updates the location map to relate LBA K to physical location X. Accordingly, the flash control module 302 reads, via the R/W module 304, from physical location X in the flash memory 210 when the flash control module 302 receives a request from the host system 102 to read from LBA K.

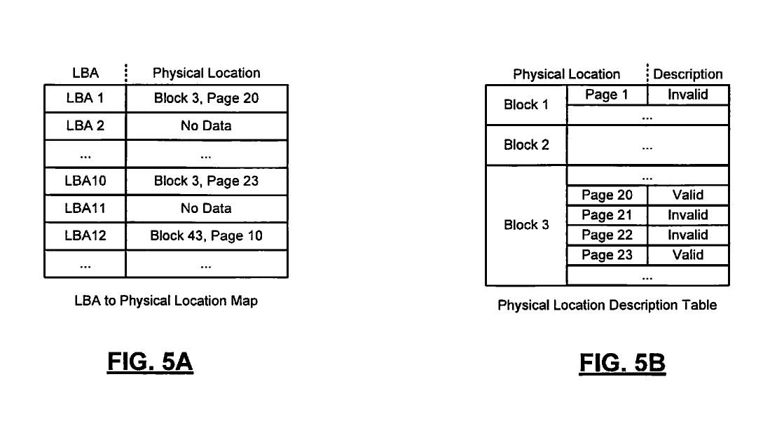

Referring now to FIG. 5A, an embodiment of a location map is shown. The location map relates LBA 1 to a physical location of (block 3, page 20). The location map relates LBA 2 to “no data.” For example, “no data” may indicate that the host system 102 has not written data to LBA 2 and/or LBA 2 does not include data.

Referring back to FIG. 3, the location description module 310 includes a physical location description table (hereinafter “description table”). The description table indicates a state of the data at a physical location. The state of the data may be one of a valid state and an invalid state. In other words, the description table indicates whether data written at a physical location of the flash memory 210 is valid or invalid. Data may be indicated as valid/invalid in units of pages.

Data initially written to a page (i.e., after erasure) corresponding to a logical address may be indicated as valid in the description table. When new data is written to a new physical location that corresponds to the same logical address, the location description module 310 updates the description table to indicate that the new physical location is valid and the old physical location is invalid.

Updating the description table after consecutive writes to the same logical address may be performed as follows. The R/W module 304 writes data, corresponding to a logical address, to a physical location.

The data at the physical location may be initially set to valid in the description table. Later, when the R/W module 304 writes new data corresponding to the same logical address at a new physical location, the data at the new physical location is set to valid in the description table. The data at the previous physical location is then set to invalid.

Referring now to FIG. 5B, an embodiment of a description table is shown. The description table indicates that data at physical location (block 1, page 1) is invalid. In other words, the description table maps an invalid state to the physical location (block 1, page 1). The description table indicates that data at physical location (block 3, page 20) is valid. In other words, the description table maps a valid state to the physical location of (block 3, page 20).

Referring back to FIG. 3, the R/W module 304 may run out of physical locations to write data to in the flash memory 210 since the R/W module 304 may not overwrite previously written pages. The flash management module 206 defragments the flash memory 210 to free up physical locations in the flash memory 210 for writing. The flash management module 206 may free up physical locations based on a number of invalid pages within blocks of the flash memory 210.

The flash management module 206 defragments the flash memory 210 in order to free at least one block. The defragmentation module 312 may select a group of blocks to defragment based on a number of invalid pages within each block. Accordingly, the defragmentation module 312 may select a group of blocks that together include a number of invalid pages greater than or equal to one block (i.e., m pages). For example, when a block includes m pages, the defragmentation module 312 selects a group of blocks that together include m or more invalid pages.

Defragmentation of the flash memory 210 may include the following operations. The defragmentation module 312 selects a group of blocks to defragment based on the number of invalid pages in each block. For example, the defragmentation module 312 selects blocks having the most invalid pages to form the group of blocks. The flash control module 302 reads the valid pages from the selected group of blocks in the flash memory 210 via the R/W module 304. The flash control module 302 writes the valid pages from the group of blocks to the memory 208. The erasing module 306 erases the group of blocks after the R/W module 304 writes the valid pages to the memory 208.

The R/W module 304 writes the valid pages to the erased group of blocks in flash memory 210. For example, the R/W module 304 may write the valid pages sequentially to the flash memory 210. Since the number of invalid pages in the group of blocks was greater than m, the flash memory 210 may include one or more entirely erased blocks after the defragmentation operation. The location mapping module 308 updates the location map after the defragmentation operation. The location description module 310 updates the description table after the defragmentation operation.

The time and resources used to perform the defragmentation operation may depend on the number of invalid pages in the flash memory 210. In general, a defragmentation process that involves transferring more valid pages between the flash memory 210 and the memory 208 requires more time and resources than transferring less valid pages. Accordingly, a larger number of invalid pages per block in the flash memory 210 may result in a more optimized defragmentation operation that uses less time and resources.

In other words, more invalid pages in the flash memory 210 may result in a defragmentation operation that includes less searching for blocks including the most invalid pages and less transferring of data between the flash memory 210 and the memory 208. In some scenarios, a single block may include all invalid pages, allowing for the block to be erased without the transfer of any data. In another scenario, for example, when two blocks each include m/2 invalid pages, the defragmentation operation may free a single block by defragmenting only 2 blocks.

Defragmentation of the flash memory 210 may be a memory intensive process that impacts the performance of the flash memory 210 as a cache memory. In other words, defragmentation uses resources to reorder data in the flash memory 210 without increasing the speed at which the host system 102 receives requested data.

A flash memory cache system according to the present disclosure invalidates pages of the flash memory 210 in order to reduce time and resources used to perform the defragmentation operation. The flash memory cache system may therefore decrease an amount of time and resources used to perform the defragmentation operation.

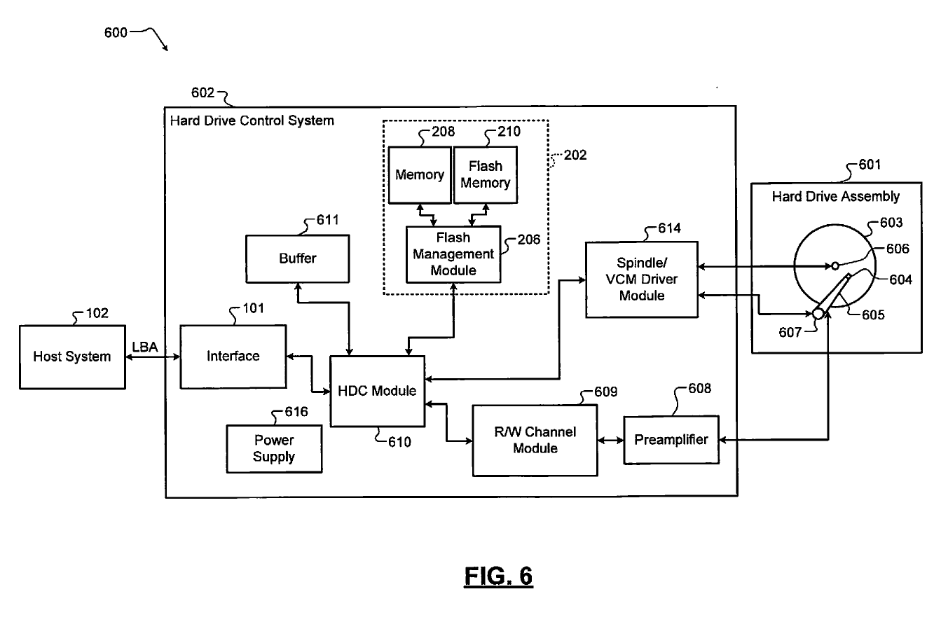

Referring now to FIG. 6, the flash memory system 202 is implemented in a flash memory cache system 600. The flash memory cache system 600 includes a hard drive assembly (HDA) 601 and a hard drive control system 602. The HDA 601 includes a magnetic medium 603, e.g., one or more platters that store data, and a read/write device 604. While the flash memory cache system 600 includes the HDA 601 as a storage device, other storage devices may be used in place of the HDA 601. For example, an optical storage device may be used in place of the HDA 601.

The read/write device 604 arranged on an actuator arm 605 reads and writes data on the magnetic medium 603. The HDA 601 includes a spindle motor 606 that rotates the magnetic medium 603 and a voice-coil motor (VCM) 607 that actuates the actuator arm 605.

The hard drive control system 602 includes a preamplifier 608. The preamplifier 608 amplifies signals generated by the read/write device 604 during read operations and provides signals to the read/write device 604 during write operations. The hard drive control system 602 also includes a read/write (R/W) channel module 609, a hard disk controller (HDC) module 610, a buffer 611, the flash memory system 202, and a spindle/VCM driver module 614.

The R/W channel module 609 processes data received from and transmitted to the preamplifier 608. The HDC module 610 controls components of the HDA 601 and communicates with the host system 102 via the interface 101.

The HDC module 610 may receive data from the HDA 601, the R/W channel module 609, the buffer 611, the flash memory system 202, the spindle/VCM driver module 614, and/or the interface 101. The HDC module 610 may process the data, including encoding, decoding, filtering, and/or formatting the data. The processed data may be output to the HDA 601, the R/W channel module 609, the buffer 611, the flash memory system 202, the spindle/VCM driver module 614, and/or the interface 101.

The HDC module 610 may use the buffer 611 and/or the flash memory system 202 to store data related to the control and operation of the flash memory cache system 600. The buffer 611 may include DRAM, SDRAM, etc. The spindle/VCM driver module 614 controls the spindle motor 606 and the VCM 607. The hard drive control system 602 includes a power supply 616 that provides power to the components of the flash memory cache system 600.

The HDC module 610 reads/writes data from/to the flash memory 210 and the HDA 601. The host system 102 may request data from the HDA 601 via the HDC module 610. For example, the host system 102 may request data from the HDA 601 using a logical block addressing scheme. The HDC module 610 may retrieve the requested data from one of the flash memory 210 and the HDA 601 and send the requested data to the host system 102.

The flash memory 210 of the flash memory cache system 600 may be referred to as a cache memory since the flash memory cache system 600 caches data in the flash memory 210. For example, the flash memory cache system 600 may cache data read from the HDA 601 or written to the HDA 601 in the flash memory 210.

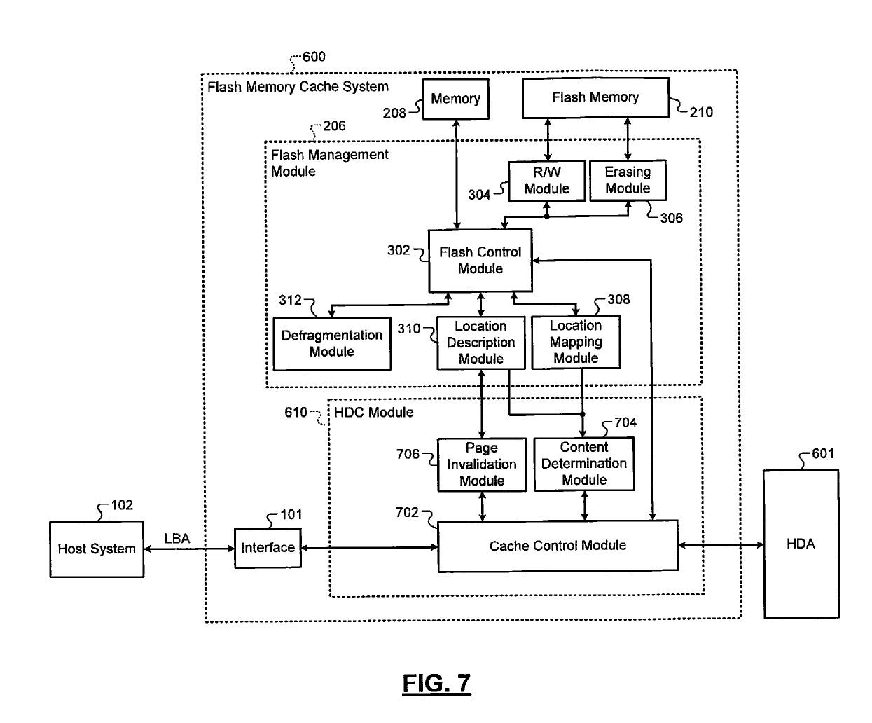

Referring now to FIG. 7, a functional block diagram illustrates the interaction between the HDC module 610, the flash management module 206, the host system 102, and the HDA 601. The HDC module 610 includes a cache control module 702, a content determination module 704, and a page invalidation module 706. The cache control module 702 controls the transfer of data between the host system 102, the flash memory 210, and the HDA 601 based on caching operations. The cache control module 702 controls the transfer of data to/from the flash memory 210 via the flash control module 302. The content determination module 704 determines what logical addresses are stored in the flash memory 210. The page invalidation module 706 may set a state of a physical location of the flash memory 210 to invalid in the description table, for example, based on a caching operation.

The content determination module 704 determines whether the flash memory 210 includes data requested by the host system 102 at a logical address. The cache control module 702 may retrieve the requested data from the flash memory 210 when the flash memory 210 includes the data requested at the logical address.

In some implementations, the content determination module 704 includes a cache address table that includes logical addresses that are stored in the flash memory 210. The cache address table relates the logical addresses that are stored in the flash memory 210 to physical addresses (e.g., block offsets) of the flash memory 210.

In some implementations, the content determination module 704 may determine a physical address in the flash memory 210 that corresponds to a logical address using the cache address table. In other implementations, the content determination module 704 may determine whether a logical address is stored in the flash memory 210, and where the logical address is stored in the flash memory 210, based on the location map and the description map illustrated in FIGS. 5A and 5B. Accordingly, the cache address table may be used in conjunction with, or in lieu of, the location map and the description map to determine where a logical address is stored in the flash memory 210. The content determination module 704 updates the cache address table to reflect data stored in the flash memory 210 when new information is written to and erased from the flash memory 210.

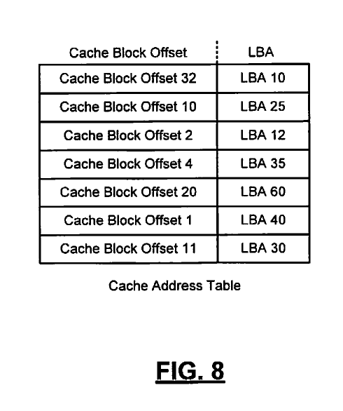

Referring now to FIG. 8, an exemplary cache address table relates a logical address to a location of cached data in the flash memory 210. The cache block offset column may indicate the physical location of data in the flash memory 210. For example, the table indicates that logical address LBA 10 is located at a physical location of cache block offset 32.

Referring back to FIG. 7, the cache control module 702 retrieves requested data from the HDA 601 when the flash memory 210 does not include the requested data. The cache control module 702 may store data retrieved from the HDA 601 in the flash memory 210 when the flash memory does not include the requested data. The location mapping module 308 updates the location map, the location description module 310 updates the description table, and the content determination module 704 updates the cache address table when data retrieved from the HDA 601 is stored in the flash memory 210.

In other words, the cache control module 702 may write data to the flash memory 210 when the cache control module 702 transfers data from the HDA 601 to the host system 102. Accordingly, the cache control module 702 may “cache data” from the HDA 601 in the flash memory 210 when the cache control module 702 receives a request for data from a logical address that the flash memory 210 does not include. In some implementations, the cache control module 702 caches data from the logical address that the flash memory 210 does not include in addition to caching data of nearby logical addresses.

The flash memory cache system 600 may retrieve requested data faster from the flash memory 210 than the HDA 601. For example, when the flash memory 210 includes a NAND flash memory, the NAND flash memory may be accessed faster than the HDA 601 during random reads. Accordingly, the flash memory cache system 600 functions to reduce a data retrieval time for the host system 102 when the host system 102 requests data from the HDA 601.

The host system 102 may command a write to at least one of the flash memory 210 and the HDA 601. The cache control module 702 may write data to the HDA 601 and store the data in the flash memory 210 when receiving a write command. Accordingly, the flash memory cache system 600 caches data written to the HDA 601. The cache control module 702 may write data to the flash memory 210 and then write the data to the HDA 601 at a later time. Accordingly, the flash memory cache system 600 may act as a buffer when the host system 102 commands a write to the HDA 601.

The cache control module 702 writes data to the flash memory 210 based on a variety of caching operations. The page invalidation module 706 sets a state of a physical location of the flash memory to invalid in the description table based on a variety of caching operations. In other words, the page invalidation module 706 invalidates physical locations of the flash memory 210 based on a caching operation. The page invalidation module 706 invalidates physical locations in the description table to reduce time and resources used to perform the defragmentation operation.

In some implementations, the page invalidation module 706 invalidates physical locations in the description table based on a command from the host system 102. For example, the host system 102 may command the page invalidation module 706 via the cache control module 702 to invalidate a physical location in the description table. The command may include an address (e.g., a LBA) corresponding to the data to invalidate and an instruction to invalidate the data. The page invalidation module 706 invalidates the data in response to the command. The host system 102 may command the page invalidation module 706 to invalidate the physical location in the description table based on a caching operation performed at the host system 102.

The page invalidation module 706 invalidates physical locations corresponding to a logical address in the following way. The page invalidation module 706 determines the physical location of the corresponding logical address based on the location map. The page invalidation module 706 then sets the state of the physical location as invalid in the description table. The location mapping module 308 then marks the corresponding logical address in the location map with “no data.”

The page invalidation module 706 invalidates pages in the location description table in order to increase the number of invalid pages included in the flash memory 210. Accordingly, the page invalidation module 706 reduces an amount of resources used during the defragmentation operation by increasing the number of invalid pages in the flash memory 210.

In general, caching operations are operations that include determining which data to store in the flash memory 210 and which data to erase from the flash memory 210. Since data is erased in units of blocks and data may be written in units of pages, the cache control module 702 may not erase a page when the cache control module 702 determines, based on a caching operation, that a page should be removed from the flash memory 210. Instead, the cache control module 702 commands the page invalidation module 706 to invalidate the page so that the invalidated page may be erased later during the defragmentation operation.

A variety of caching operations are described hereinafter. The cache control module 702 may implement a first-in first-out (FIFO) caching operation, wherein the cache control module 702 replaces the oldest data in the flash memory 210 with the newer data. For example, the cache control module 702 may command the page invalidation module 706 to invalidate the oldest data in the flash memory 210. The cache control module 702 may then erase the invalidated data to make space for newer data in the flash memory 210.

The cache control module 702 may implement a least recently used (LRU) caching operation, wherein the cache control module 702 discards data from the flash memory 210 that is least recently used. For example, the cache control module 702 may command the page invalidation module 706 to invalidate data from the flash memory 210 that is least recently used so the least recently used data may be erased from the flash memory 210.

The cache control module 702 may implement a least frequently used (LFU) caching operation, wherein the cache control module 702 discards data from the flash memory 210 that is least frequently used. For example, the cache control module 702 may command the page invalidation module 706 to invalidate the data from the flash memory 210 that is least frequently used so the least frequently used data may be erased from the flash memory 210.

The location mapping module 308, the location description module 310, and the content determination module 704 update the corresponding tables accordingly when the HDC module 610 implements one of the caching operations in order to invalidate and write data in the flash memory 210. While FIFO, LRU, and LFU caching operations are described above, the cache control module 702 may implement other caching operations to determine which physical locations to invalidate.

In some scenarios, the flash memory 210 may run out of physical locations for data to be written to. The cache control module 702 may determine that the flash memory 210 is full when there are no more available pages to write to or the number of pages available is less than a threshold amount. The cache control module 702 may then instruct the page invalidation module 706 to invalidate physical locations of the flash memory 210.

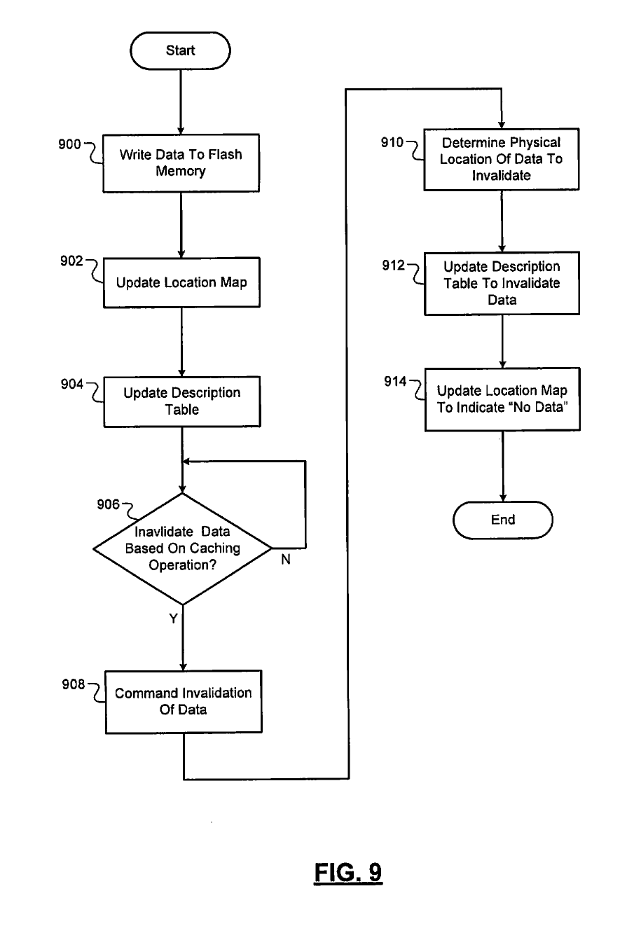

Referring now to FIG. 9, a method for invalidating a physical location of a flash memory starts at 900. At 900, the R/W module 304 writes data to the flash memory 210. At 902, the location mapping module 308 updates the location map based on the data written to the flash memory 210. At 904, the location description module 310 updates the description table based on the data written to the flash memory 210. At 906, the cache control module 702 determines whether to invalidate the data based on a caching operation. If the result at 906 is false, the method repeats 906. If the result at 906 is true, the method continues at 908. At 908, the cache control module 702 commands the page invalidation module 706 to invalidate the data. At 910, the page invalidation module 706 determines the physical location of the data to be invalidated (e.g., based on the location map). At 912, the page invalidation module 706 sets the state of the data to invalid in the description table to invalidate the data. At 914, the location mapping module 308 updates the location map to indicate that the physical location includes “no data.”

The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A system comprising:
a control module configured to write data received from a host system to a storage medium, read data from the storage medium, and cache data from at least one of the host system and the storage medium in a flash memory;
a location description module configured to map one of a valid state and an invalid state to a physical location of a subset of data in the flash memory; and
a page invalidation module configured to:
receive a command that includes an address corresponding to the subset and an instruction to set a state of the physical location of the subset to the invalid state; and
set the state of the physical location of the subset to the invalid state in response to the command, wherein the command is received from one of the host system and the control module.

2. The system of claim 1, wherein the storage medium includes one of a magnetic storage medium and an optical storage medium.

3. The system of claim 1, wherein the flash memory includes a NAND flash memory.

4. The system of claim 1, wherein the physical location of the subset corresponds to a block and page of the flash memory.

5. The system of claim 1, further comprising a location mapping module configured to map the physical location of the subset to a logical address, wherein the logical address corresponds to a physical location on the storage medium.

6. The system of claim 5, wherein the location mapping module includes a map that relates the physical location of the subset to the logical address, and wherein the location mapping module updates the map to indicate that no data is stored at the logical address when the page invalidation module sets the state of the physical location of the subset to the invalid state.

7. The system of claim 1, further comprising a defragmentation module configured to defragment a block of the flash memory that includes the subset, wherein the page invalidation module sets the state of the physical location of the subset to the invalid state in response to the command.

8. The system of claim 7, wherein the subset is a first subset, wherein the block includes a second subset of data and a third subset of data, wherein physical locations corresponding to the second and third subsets each have the valid state, and wherein the defragmentation module erases the first subset and writes the second and third subsets to new physical locations when defragmenting the block.

9. The system of claim 1, wherein the address is a logical block address when the command is received from the host system.

10. The system of claim 1, wherein the control module is a hard disk control module and the storage medium is a hard disk drive.

11. A method comprising:
writing data received from a host system to a storage medium;
reading data from the storage medium;
caching data from at least one of the host system and the storage medium in a flash memory;
mapping one of a valid state and an invalid state to a physical location of a subset of data in the flash memory;
receiving a command that includes an address corresponding to the subset and an instruction to set a state of the physical location of the subset to the invalid state; and
setting the state of the physical location of the subset to the invalid state in response to the command, wherein the command is received from one of the host system and a control module.

12. The method of claim 11, wherein the storage medium includes one of a magnetic storage medium and an optical storage medium.

13. The method of claim 11, wherein the flash memory includes a NAND flash memory.

14. The method of claim 11, further comprising mapping the physical location of the subset to a logical address, wherein the logical address corresponds to a physical location on the storage medium.

15. The method of claim 14, further comprising updating a map to indicate that no data is stored at the logical address when setting the state of the physical location of the subset to the invalid state, wherein the map relates the physical location of the subset to the logical address.

16. The method of claim 11, further comprising:
defragmenting a block of the flash memory that includes the subset; and
setting the state of the physical location of the subset to the invalid state in response to the command.
